(19) United States
(12) Patent Application Publication
(10) Pub. No.: US 2023/0373337 A1
(43) Pub. Date: Nov. 23, 2023

(54) Methods and Systems for Charging an Electric Vehicle

(71) Applicant: Ford Global Technologies, LLC, Dearborn, MI (US)

(72) Inventors: Owen David Styles, Chelmsford (GB); William John Mallard, Southend on Sea (GB)

(21) Appl. No.: 17/746,557

(22) Filed: May 17, 2022

(51) Int. Cl. B60L 53/66; B60L 53/30; B60L 53/10; B60L 53/62; B60L 53/65

(52) U.S. Cl. CPC B60L 53/66; B60L 53/305; B60L 53/10; B60L 53/62; B60L 53/65

(57) ABSTRACT

A method of charging an electric vehicle and a system comprising a processor and charging circuitry operable to charge an electric vehicle is described. The method comprises predicting, for the electric vehicle, an energy consumption profile for an itinerary comprising one or more tasks. The method further comprises determining a charging profile that determines a minimum amount of charge required by the electric vehicle to perform the itinerary based on the predicted energy consumption profile. The method further comprises supplying, based on the charging profile, the electric vehicle with the determined minimum amount of charge required to perform the itinerary.

### BACKGROUND

The present disclosure relates to a method of charging an electric vehicle and a system comprising a processor and charging circuitry to charge an electric vehicle. Particularly, but not exclusively, the present disclosure relates to predicting, for the electric vehicle, an energy consumption profile for an itinerary.

### SUMMARY

With further advancement in vehicle battery technology, the demand for increased efficiency in charging technologies is becoming more evident. Presently, a vehicle's battery may be charged (in the case of a hybrid vehicle) by an internal combustion engine within the vehicle. Alternatively, the vehicle may be plugged into an electric charging station which charges the vehicle's battery until it is fully charged (for example, overnight). In this scenario, the vehicle may be fully charged well in advance of the user unplugging the vehicle from the charging station, leaving a large amount time between the vehicle being fully charged and the vehicle being used where the charging station is not being used. The vehicle may also be plugged into the electric charging station for a short amount of time (for example, if the user decides to charge the vehicle at a rest station over a break at lunch time). In this scenario, two potential problems may arise: i) the vehicle may not need to be charged at that point for the user to reach their destination, which unnecessarily charges that vehicle and prevents another vehicle from being charged; or ii) the vehicle may not be supplied with sufficient charge for the user to reach their next destination. Accordingly, there is a need to reduce unnecessary time spent plugged into an electric charging station. There is also a need to predict the amount of charge required by a vehicle to reach a next destination.

A further problem is presented to users with increased electric systems (for example, but not limited to air conditioning (AC) and heating systems, interior lighting, navigation systems, and Hi-Fi systems) on vehicles. Moreover, some vehicles may have the ability to utilize part of the vehicle's energy store for alternative purposes, such as charging gadgets/tools or powering electrical equipment (for example, but not limited to power drills, electric saws, nail guns, and camping equipment such as electric refrigerators). In either case, a user may complete an outbound journey and then utilize too much of their available energy store causing them to be unable to complete a return journey without recharging along the way. Predicting how much energy is required for a vehicle can be difficult due to the user's specific consumption profile. For example, Driver A may exhibit a heavy energy consumption profile, (for example, based on harsher driving, excessive tool use/recharging, AC usage, etc., whereas Driver B may have a lower energy consumption profile, for example, based on smoother driving, different types of jobs, and less tool usage, etc.). To overcome this problem, vehicles are often over-charged to reduce the likelihood of running out of energy mid-journey, despite energy consumption optimization. Such over-charging, (for example, on a routine basis) can lead to higher energy consumption which, in turn, leads to a higher environmental footprint and a higher energy bill for the user.

Accordingly, there is a need in the industry to determine a minimum amount of charge required for an electric vehicle (for example, as part of a plurality of electric vehicles in a fleet) based on a predicted usage of the electric vehicle and its electrical accessories.

The invention is a method of charging an electric vehicle, the method comprising predicting, for the electric vehicle, an energy consumption profile for an itinerary comprising one or more tasks (such as, but not limited to, an activity, a job, or an act of business/pleasure). For example, a prediction can be made, based on historic data, for how much energy will be required for a particular vehicle-accessory-driver-job combination. The method further comprises determining a charging profile that defines a minimum amount of charge required by the electric vehicle to perform the itinerary based on the predicted energy consumption profile. For example, an average amount of energy may be determined for a specific type of itinerary carried out by a specific driver using a vehicle having assigned tools. The method further comprises supplying, based on the charging profile, the electric vehicle with the determined minimum amount of charge required to perform the itinerary. For example, the minimum amount of charge may then be supplied to the electric vehicle. In some cases, certain vehicles may have different discharge profiles, for example, due to age. As a result, those vehicles may require more charge than new vehicles. Based on the above, a charge strategy can be determined for an electric vehicle as well as a fleet of electric vehicles to minimize the total aggregate energy supplied to the electric vehicles on a routine basis.

In some examples, the predicted energy consumption profile optionally comprises an amount of energy for traveling between locations associated with the itinerary. In a further example, the predicted energy consumption profile optionally comprises utilizing at least one vehicle accessory which is associated operationally with performing the itinerary.

In some examples, the energy consumption profile is predicted based on the habits of a driver of the vehicle (for example, but not limited to, harsher/smoother driving, excessive/minimal tool use/recharging, AC usage, etc.).

In some examples, the energy consumption profile is predicted based on at least one of a plurality of contextual factors. The contextual factors comprise any one of: a vehicle use pattern (for a similar itinerary), a vehicle accessory use pattern (for a similar itinerary), a number of required vehicle occupants for each task of the itinerary, a physical characteristic of at least one required vehicle occupant for each task of the itinerary, and a charge profile of at least one accessory associated with the vehicle requiring charge during each task of the itinerary.

In some examples, predicting the energy consumption profile further comprises determining a threshold amount of energy required for a specific itinerary carried out by a specific driver using a vehicle having assigned accessories.

In some examples, predicting the energy consumption profile further comprises implementing machine learning to dynamically update the predicted energy consumption profile.

In some examples, determining the charging profile comprises determining an itinerary starting time when the electric vehicle is required to start performing the itinerary, and determining a threshold charging duration required to supply the electric vehicle with the determined minimum amount of charge required to perform the itinerary. Determining the charging profile further comprises scheduling a charging start time and/or finishing time for supplying the electric vehicle with the determined amount of charge required to perform the itinerary before the itinerary starting time (for example, to provide enough time for the threshold charging duration to pass before the vehicle is required).

In some examples, the charging profile comprises determining when at least one vehicle accessory of the electric vehicle is required for use during the itinerary, and determining a threshold charging duration required to supply the at least one vehicle accessory with a minimum amount of charge required for use during the itinerary. The charging profile further comprises scheduling a charging start time and/or finishing time for supplying the at least one vehicle accessory with the determined minimum amount of charge required for use during the itinerary (for example, to provide enough time for the threshold charging duration to pass before the at least one vehicle accessory is required). For example, the charge strategy may extend to scheduling the charging of tools and accessories, for example, mid-itinerary schedule, to ensure that tools are charged to the minimum required level just in time for completing the itinerary. In this way, energy is not wasted in overcharging tools and accessories from the vehicle's battery.

In some examples, the method further comprises supplying, based on the charging profile, the at least one vehicle accessory with the minimum amount of charge required for use during the itinerary from a vehicle battery before a starting time of the itinerary and/or during the itinerary.

In some examples, the method further comprises determining a state of charge of a vehicle battery and/or a vehicle accessory during the itinerary, and updating the charging profile (for example, with the implementation of Machine Learning) during the itinerary based on the determined state of charge of the vehicle battery and/or the vehicle accessory.

According to some examples in accordance with an aspect of the disclosure, a system for charging an electric vehicle is provided. The system comprises a processor operable to predict, for the electric vehicle, an energy consumption profile for an itinerary comprising one or more tasks (such as, but not limited to, an activity, a job, or an act of business/pleasure). For example, a prediction can be made, based on historic data, for how much energy will be required for a particular vehicle-accessory-driver-job combination. The processor is further operable to determine a charging profile that defines a minimum amount of charge required by the electric vehicle to perform the itinerary based on the predicted energy consumption profile. For example, an average amount of energy may be determined for a specific type of itinerary carried out by a specific driver using a vehicle having assigned tools. The system further comprises charging circuitry controlled by the processor, wherein the charging circuitry is operable to supply, based on the charging profile, the electric vehicle with the determined minimum amount of charge required to perform the itinerary. For example, the minimum amount of charge may then be supplied to the vehicle. In some cases, certain vehicles may have different discharge profiles, for example, due to age. As a result, those vehicles may require more charge than new vehicles. Based on the above, a charge strategy can be determined for a single electric vehicle or fleet of electric vehicles to minimize the total aggregate energy supplied to the vehicles on a routine basis.

In some examples, the predicted energy consumption profile optionally comprises an amount of energy for traveling between locations associated with the itinerary. In a further example, the predicted energy consumption profile optionally comprises utilizing at least one vehicle accessory which is associated operationally with performing the itinerary.

In some examples, the energy consumption profile is predicted based on the habits of a driver of the vehicle (for example, but not limited to, harsher/smoother driving, excessive/minimal tool use/recharging, AC usage, etc.).

In some examples, the energy consumption profile is predicted based on at least one of a plurality of contextual factors. The contextual factors comprise any one of: a vehicle use pattern (for a similar itinerary), a vehicle accessory use pattern (for a similar itinerary), a number of required vehicle occupants for each task of the itinerary, a physical characteristic of at least one required vehicle occupant for each task of the itinerary, and a charge profile of at least one accessory associated with the vehicle requiring charge during each task of the itinerary.

In some examples, predicting the energy consumption profile further comprises the processor being operable to determine a threshold amount of energy required for a specific itinerary carried out by a specific driver using a vehicle having assigned accessories.

In some examples, predicting the energy consumption profile further comprises the processor being operable to implement machine learning to dynamically update the predicted energy consumption profile.

In some examples, the processor is further operable to determine an itinerary starting time when the electric vehicle is required to start performing the itinerary, and to determine a threshold charging duration required to supply the electric vehicle with the determined minimum amount of charge required to perform the itinerary. The processor is yet further operable to schedule a charging start time and/or finishing time for supplying the electric vehicle with the determined amount of charge required to form the itinerary before the itinerary starting time (for example, to provide enough time for the threshold charging duration to pass before the vehicle is required).

In some examples, the charging profile comprises determining, by the processor, when at least one vehicle accessory of the electric vehicle is required for use during the itinerary, and determining, by the processor, a threshold charging duration required to supply the at least one vehicle accessory with a minimum amount of charge required for use during the itinerary. The charging profile further comprises scheduling, by the processor, a charging start time and/or finishing time for supplying the at least one vehicle accessory with the determined minimum amount of charge required for use during the itinerary (for example, to provide enough time for the threshold charging duration to pass before the at least one vehicle accessory is required). For example, the charge strategy may extend to scheduling the charging of tools and accessories, for example, mid-itinerary schedule, to ensure that tools are charged to the minimum required level just in time for completing the itinerary. In this way, energy is not wasted in overcharging tools and accessories from the vehicle's battery.

In some examples, the charging circuitry is further operable to supply, based on the charging profile, the at least one vehicle accessory with the minimum amount of charge required for use during the itinerary from a vehicle battery before a starting time of the itinerary and/or during the itinerary.

In some examples, the processor is further operable to determine a state of charge of a vehicle battery and/or a vehicle accessory during the itinerary, and to update the charging profile (for example, with the implementation of Machine Learning) during the itinerary based on the determined state of charge of the vehicle battery and/or the vehicle accessory.

According to some examples, in accordance with another aspect of the disclosure, a vehicle is provided. The vehicle comprises a system for charging an electric vehicle. The system comprises a processor operable to predict, for an electric vehicle, an energy consumption profile for an itinerary comprising one or more tasks. The processor is further operable to determine a charging profile that defines a minimum amount of charge required by the electric vehicle to perform the itinerary based on the predicted energy consumption profile. The system further comprises charging circuitry controlled by the processor, wherein the charging circuitry is operable to supply, based on the charging profile, the electric vehicle with the determined minimum amount of charge required to perform the itinerary.

In the context of the present disclosure, a vehicle or an electric vehicle may be any appropriate type of vehicle, such as an automobile, a motorbike, a marine vessel, or an aircraft. In some examples, the vehicle may be any appropriate type of hybrid vehicle, such as a Hybrid Electric Vehicle (HEV), a Plug-in Hybrid Electric Vehicle (PHEV), a Mild Hybrid Electric Vehicle (mHEV), or any other vehicle having an engine and an electrified powertrain. In some examples, the systems and methods described herein may be used on or with any machinery or equipment, for example, a generator, requiring operational control by a user/operator.

Moreover, in the context of the present disclosure, the term “driver” or “user” may mean any person who operates a vehicle or any machinery or equipment.

These examples and other aspects of the disclosure will be apparent and elucidated with reference to the example(s) described hereinafter. It should also be appreciated that particular combinations of the various examples and features described above and below are often illustrative and any other possible combination of such examples and features are also intended, notwithstanding those combinations that are intended as mutually exclusive.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates a charging network, in accordance with some examples of the disclosure;

FIG. 2 illustrates a vehicle, in accordance with some examples of the disclosure;

FIG. 3 is a circuit diagram of a control circuitry comprising a processor for a charging network, in accordance with some examples of the disclosure;

FIG. 4 illustrates a plurality of charging stations, in accordance with some examples of the disclosure;

FIG. 5 is a graph illustrating a battery charging and discharging profile of a vehicle, in accordance with some examples of the disclosure;

FIG. 6 is a flow chart illustrating a method of charging at least one of a plurality of vehicles, in accordance with some examples of the disclosure; and

FIG. 7 is a flow chart illustrating further examples of a method of charging at least one of a plurality of vehicles, in accordance with some examples of the disclosure.

### DETAILED DESCRIPTION

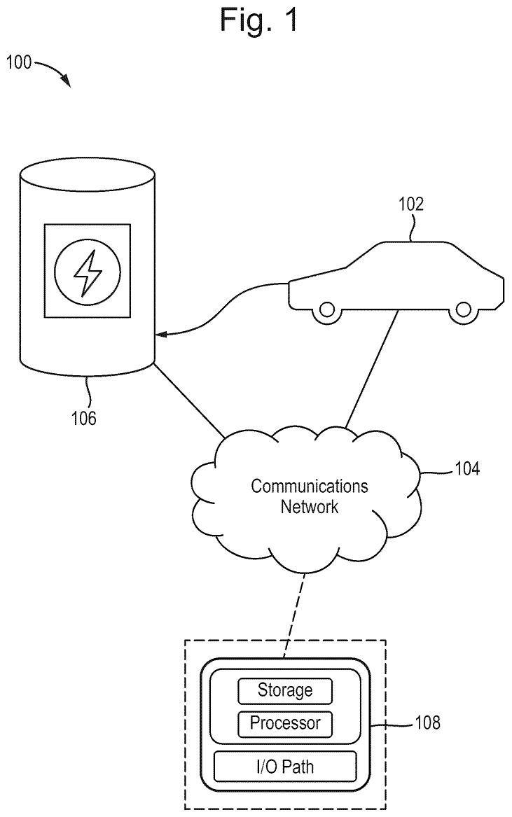

FIG. 1 illustrates a charging network 100, comprising a vehicle 102, a communications network 104, a charging station 106, and a control circuitry 108 as described below. The vehicle 102 may be an electric vehicle, any appropriate type of hybrid vehicle, such as a Hybrid Electric Vehicle (HEV), a Plug-in Hybrid Electric Vehicle (PHEV), a Mild Hybrid Electric Vehicle (mHEV), or any other vehicle having an engine and an electrified powertrain. Vehicle 102, charging station 106 and control circuitry 108 may each comprise processing capabilities operable to send and receive transmissions from and to the communications network 104. For example, vehicle 102 may comprise an electronic control unit (ECU) and input/output transceivers. Charging station 106 and control circuitry 108 may each comprise an on-board processor, storage and input/output transceivers. The control circuitry 108 comprises a processor as described in more detail with reference to FIG. 3 below, wherein the processor is operable to send and receive transmissions to the vehicle 102 and the charging station 106. As discussed above, the control circuitry 108 may comprise processing capabilities (for example, a processor, memory and input/output transmitters) operable to send and receive transmissions from and to the vehicle 102 and/or charging station 106. As shown in FIG. 1, the control circuitry may be separate to the vehicle 102 and the charging station 106. In other examples, control circuitry 108 may be placed in the vehicle 102 or the charging station 106.

Charging network 100 may comprise a plurality of control circuitries, similar to control circuitry 108, wherein the vehicle 102 and the charging station 106 each comprise a control circuitry 108. The charging station 106 may be any appropriate means of charging a battery of the vehicle 102 such as, but not limited to, a commercial charging unit (for example, as found in city centers or in service stations) or a personal charging unit (for example, a wall-mounted or free-standing unit in a user's garage or driveway). Charging network 100 is not limited to a single vehicle 102 and/or a single charging station 106.

In some examples, a plurality of vehicles 102 and/or a plurality of charging stations 106 may be part of the charging network 100. For example, charging network 100 may comprise one charging station 106 operable to charge (with multiple charging ports) a plurality of electric vehicles 102. Similarly, charging network 100 may comprise a plurality of charging stations 106 operable to charge a plurality of vehicles 102 with each charging station 106 being operable to charge a single electric vehicle 102 or a plurality of electric vehicles 102.

Charging network 100 provides a method of charging (for example, by the charging station 106) an electric vehicle 10. In some examples, the method is performed by a processor of the control circuitry 108 in communication (via communications network 104) with charging circuitry (not shown) of the charging station 106. The method of charging the electric vehicle 102 comprises predicting, for the electric vehicle 102, an energy consumption profile for an itinerary comprising one or more tasks. The one or more tasks comprise any type of operations performed by the electric vehicle 102. A task may comprise the electric vehicle 102 traveling from a first location to a second location. Alternatively, a task may comprise utilizing at least one vehicle accessory for a duration of time. A vehicle accessory may part of the electric vehicle 102 (such as, but not limited to, air conditioning (AC) and heating systems, interior lighting, navigation systems, and Hi-Fi systems) or may be a gadget/tool plugged into the vehicle 102 (such as, but not limited to power drills, electric saws, nail guns, and camping equipment such as electric refrigerators). Accordingly, the electric vehicle's 102 itinerary may range from any number of simple operations (for example, being able to drive to a determined destination and returning back to the initial starting point) to any number of complex operations (for example, factoring in use of gadgets and/or tools in the vehicle and also factoring in multiple destinations before returning to the initial starting point, wherein some of the destinations may comprise charging stations 106 where the vehicle 102 can be charged).

After predicting an energy consumption profile, a charging profile is determined that defines a minimum amount of charge required by the electric vehicle 102 to perform the itinerary based on the predicted energy consumption profile. For example, an average amount of energy may be determined for a specific itinerary carried out by a specific driver using a vehicle 102 having assigned tools.

Based on the determined charging profile, the electric vehicle 102 is supplied with the determined minimum amount of charge required to perform the itinerary. For example, the processor of control circuitry 108 may instruct charging circuitry of the charging station 106 to supply the minimum amount of charge to the electric vehicle 102. In some cases, certain vehicles may have different discharge profiles, for example, due to age. As a result, those vehicles may require more charge than new vehicles. Advantageously, a charge strategy can be determined for a fleet of vehicles to minimize the total aggregate energy supplied to the vehicles on a routine basis.

Further features and advantages of the method will become apparent in the following paragraphs, along with particular reference to FIG. 5.

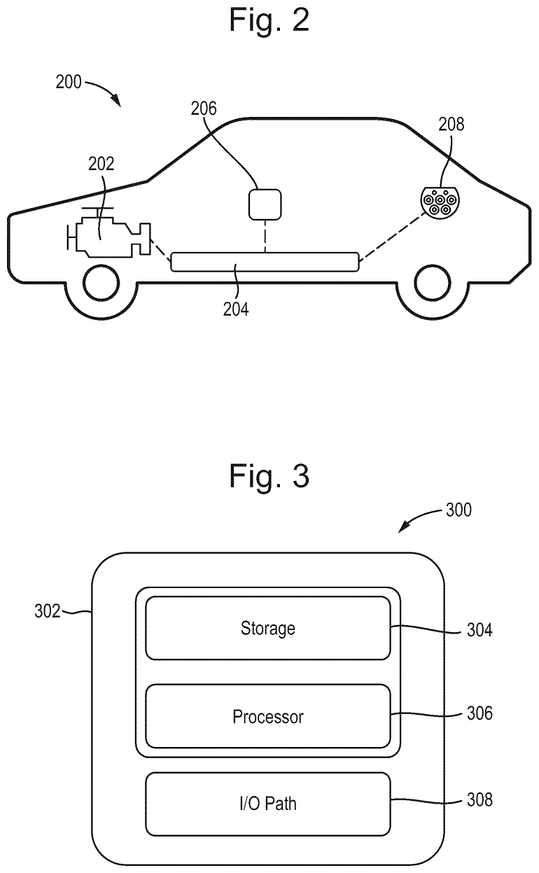

FIG. 2 illustrates a vehicle 200 substantially corresponding to the vehicle 102 as described in FIG. 1 above. Vehicle 200 may comprise a motor 202, which may be an internal combustion engine, electric motor, a combination of the two, or any other suitable means of propelling the vehicle 200. Vehicle 200 may comprise at least one rechargeable battery 204 operationally coupled to the motor 202. In some examples, the battery 204 is operable to power the motor 202. In further examples, the battery 202 is operable to power accessories 206 operationally coupled to the battery 204 (for example, tools and/or gadgets within the vehicle 200 or plugged into the vehicle 200). The battery 202 may also be operable to charge any one of the accessories 206. The battery 204 may be operationally coupled to a charging port 208 to connect the battery 204 to a charging station (for example, charging station 106 as described above with reference to FIG. 1). The charging port 208 may be any suitable port for coupling the vehicle's battery 204 to a charging station (for example, any suitable plug and socket arrangement). As described above with reference to FIG. 1, vehicle 200 may comprise a control circuitry 108 (not shown) comprising a processor to communicate with charging station 106 (via communications network 104) to carry out the method of charging the electric vehicle 102, 200.

FIG. 3 is a circuit diagram 300 of a control circuitry 302 corresponding to control circuitry 108 as described above with reference to FIG. 1 and comprising a processor 306 for a charging network (for example, charging network 100 as described above with reference to FIG. 1), in accordance with some examples of the disclosure. Circuit diagram 300 has a control circuitry 302 comprises storage 304, processor 306, and an in input/output (I/O) path 308. The storage 304 contains program data for instructing the processor 306 to run one or more programs that process incoming signals from the I/O path 308 and provide output signals via the I/O path 308. The output signals are mainly interpreted by the circuitry that receives them as commands. In the present context, incoming signals can include those from a vehicle (for example, electric vehicle 102 as described with reference to FIG. 1) and/or a charging station (for example, charging station 106 as described with reference to FIG. 1).

As described above, charging network 100 may comprise one or a plurality of control circuitry 108, 300. Control circuitry 108, 300 may be placed in each electric vehicle 102 of the charging network 100, in each charging station 106 of the charging network 100, or separately from each electric vehicle 102 and/or charging station 106.

As part of the charging network, processor 306 may be operable to perform a method of charging (for example, by the charging station 106) an electric vehicle 102. Therein, the processor is operable to predict, for the electric vehicle 102, an energy consumption profile for an itinerary comprising one or more tasks. The itinerary may range from any number of simple operations to any number of complex operations as described above. The processor 306 is further operable to determine a charging profile that defines a minimum amount of charge required by the electric vehicle 102 to perform the itinerary based on the predicted energy consumption profile. The processor 306 is further operable to supply, based on the charging profile, the electric vehicle 102 with the determined minimum amount of charge required to perform the itinerary.

In some examples, processor 306 may be operable to instruct charging station 106 to stop charging a first electric vehicle 102 and switch its charging capacities to a second electric vehicle coupled to charging station 106 when it is determined that the first electric vehicle 102 has been supplied with the determined minimum amount of charge required to perform its itinerary (as described above with reference to FIG. 1). Advantageously, a charge strategy can be determined for a fleet of vehicles to minimize the total aggregate energy supplied to the electric vehicles on a routine basis.

Additional features performed by the processor 306 are described below with reference to FIG. 5.

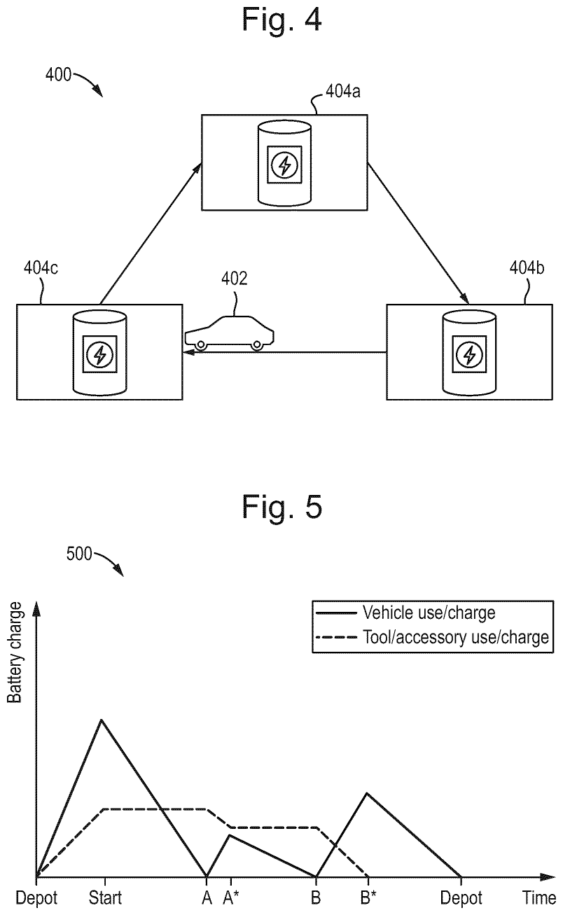

FIG. 4 illustrates a plurality of charging stations 404a to 404c, in accordance with some examples of the disclosure. Charging stations 404a to 404c may each be substantially the same as charging station 106 as described with reference to FIG. 1. In the example shown in FIG. 4, a vehicle 402 (substantially the same as vehicle 102 of FIG. 1 and vehicle 200 of FIG. 2) may travel from one intermediate stop to another intermediate stop, before reaching its final destination. Some of the stops may be at or near one of charging stations 404a to 404c (for example, the driver may want to visit someone who lives next to a street charging station before returning home).

If it is predicted that the vehicle 402 will make intermediate stops at charging stations 404a to 404c, this provides an opportunity for topping up the vehicle 402 at any one of those various intermediate charging stations 404a to 404c. With such a prediction, the vehicle 402 would only need to be sufficiently charged to reach any one of the intermediate charging stations 404a to 404c (instead of being fully charged). The remaining charge required to reach the next predicted destination from an intermediate charging station 404a to 404c can be topped up at the intermediate charging station where the vehicle 402 is temporarily parked (for example, the street charging station where the driver is visiting someone). Accordingly, a task (as described above with reference to FIG. 1) for electric vehicle 102, 200, 402 may be to reach the next predicted charging station 404a to 404c where electric vehicle 102, 200, 402 may be charged to reach its next predicted destination (for example, a further intermediate stop with a charging station 404a to 404c or the electric vehicle's point of origin). Accordingly, electric vehicle 102, 200, 402 can be charged just in-time for the upcoming predicted itinerary (comprising one or more tasks).

The example of just-in-time charging can be applied to a number of other factors based on the predicted energy consumption profile for the itinerary. For example, the amount of predicted time spent at each of any intermediate charging stations 404a to 404c would be taken into account to ensure that the electric vehicle 402 is always supplied with at least the minimum amount of charge required to reach the next destination. Additionally, if it is determined that the itinerary performed by the vehicle 402 includes the use and/or charging of internal or external gadgets, this extra energy consumption would be added to the predicted energy consumption profile for the itinerary. Accordingly, it is ensured that the electric vehicle 402 is supplied with at least the minimum amount of charge required to reach the next destination and to use and/or charge any internal or external gadgets until the next charging opportunity is reached (for example, any one of charging stations 404a to 404c).

In FIG. 4 depicts an environment 400 400 comprising three different charging stations 404a to 404c, however, this is merely for exemplary purposes. The environment 400 may comprise any number of charging networks 404*. Charging stations 404* can either be coupled to together as part of a national electric grid, be powered separately (for example, by a generator), or may be a combination of the two.

FIG. 5 is a graph illustrating an example battery charging and discharging profile for a vehicle (for example electric vehicle 102, 200 and 402 as described above with reference to FIGS. 1, 2 and 4) carrying out an itinerary comprising one or more tasks, in accordance with some examples of the disclosure. Charging of the electric vehicle 102, 200, 402 as described below occurs via charging networks (such as charging network 100 comprising charging stations 106 as described in FIG. 1 and charging stations 404a to 404c as described in FIG. 4). FIG. 5 illustrates a vehicle 102, 200, 402 departing from a depot and making intermediate stops at two places (A and B) before returning to the depot. The illustrative example of FIG. 5 is not to be construed as limiting. An electric vehicle 102, 200, 402 may depart from any other location (for example, any suitable starting location, or any location mid-way between the vehicle's depot). Moreover, the electric vehicle 102, 200, 402 can make any number of interim stops (including zero) before returning to a starting location. In some examples, the electric vehicle 102, 200, 402 may not return to a starting location.

Graph 500 in FIG. 5, depicts a time/battery charge graph, with time increasing on the x-axis and battery charge level increasing on the y-axis. At the starting point of time, a vehicle 102, 200, 402 may be at a starting location (for example, parked at a user's home or depot after returning from performing a previous itinerary). At this stage, or at any other time prior to the vehicle performing the task, an energy consumption profile is predicted for an upcoming itinerary of the vehicle 102, 200, 402. The energy consumption profile may be predicted by a processor (for example, processor 304 as described with reference to FIG. 3). As described above, the itinerary may comprise one or more tasks and a task may comprise the electric vehicle 102 traveling from a first location to a second location. Alternatively, a task may comprise utilizing at least one vehicle accessory for a duration of time. A vehicle accessory may part of the vehicle 102 (such as, but not limited to, air conditioning (AC) and heating systems, interior lighting, navigation systems, and Hi-Fi systems) or may be a gadget/tool plugged into the vehicle 102 (such as, but not limited to power drills, electric saws, nail guns, and camping equipment such as electric refrigerators). Accordingly, the electric vehicle's 102 itinerary may range from any number of simple operations (for example, being able to drive to a determined destination and returning back to the initial starting point) to any number of complex operations (for example, factoring in use of gadgets and/or tools in the vehicle and also factoring in multiple destinations before returning to the initial starting point, wherein some of the destinations may comprise charging stations 106 where the vehicle 102 can be charged).

Based on the predicted energy consumption profile, a charging profile is determined (for example, by the processor 304 as shown in FIG. 3) that defines a minimum amount of charge required by the electric vehicle 102, 200, 402 to perform the itinerary based on the predicted energy consumption profile. In the example of graph 500, a minimum charge required may correspond to the electric vehicle 102, 200, 402 being sufficiently charged to reach interim destination A from the depot. In a further example, also depicted in graph 500, the minimum charge required may additionally comprise being able to power/charge accessories at interim destination A as described below. Based on the determined charging profile, the electric vehicle 102, 200, 402 will automatically be supplied (for example, by charging circuitry of a charging station 106, 404 as described above with reference to FIGS. 1 and 4 instructed by a processor 304 as described with reference to FIG. 3) with the determined minimum amount of charge required to perform the itinerary. Furthermore, processor 304 may automatically stop charging electric vehicle 102, 200, 402 once the determined minimum amount of charger required to perform the itinerary has been supplied.

The time/battery charge graph depicted in graph 500 and described herein is not limited to a single electric vehicle 102, 200, 402, but may also apply to a plurality of electric vehicles 102, 200, 402 within a larger fleet. In such examples, predicting an energy consumption profile and determining a charging profile defining a minimum amount of charge required can be done for a single electric vehicle 102, 200, 402 within the fleet or any number of electric vehicles 102, 200, 402 within the fleet.

The predicted energy consumption profile may comprise an amount of energy (for example, battery charge) required for traveling between locations associated with the itinerary. Additionally, or alternatively, the predicted energy consumption profile may comprise utilizing at least one vehicle accessory (such as accessories 206, as described with reference to FIG. 2 above) associated operationally with performing the itinerary. In the example depicted in FIG. 5, the electric vehicle's 102, 200, 402 predicted itinerary is an itinerary involving a first journey from the depot to a first interim stop A, a second journey from there to interim stop B and a then a return journey from there to the depot. The electric vehicle's 102, 200, 402, battery charge for the journey is shown in the solid line of the graph 500. The electric vehicle's 102, 200, 402 predicted itinerary also includes powering/charging accessories 206 at interim destination A (between time A and A*) and at interim destination B (between time B and B*). The electric vehicle's 102, 200, 402 battery charge for the powering/charging of the accessories 206 is shown in the dashed line of the graph 500.

The itinerary may be defined as a series of tasks performed between two charging stations 106, 404. For example, in the graph 500 the interim stops A and B each comprise a charging station 106, 404. Moreover, in that example, the electric vehicle 102, 200, 402 is predicted to stop at each of those stops for a predetermined duration (for example between A and A* and between B and B*). At stop A the electric vehicle 102, 200, 402 will be stopped, however, it is predicted that the electric vehicle 102, 200, 402 will require a minimum amount of battery charge to utilize at least one accessory 206 as demonstrated by the dashed line between A and A*. Accordingly, the minimum amount of charge supplied to the electric vehicle 102, 200, 402 at the depot would be sufficient charge to allow the electric vehicle 102, 200, 402 to travel to destination A and to utilize the predicted number of accessories 206 between A and A*. Furthermore, the time duration between A and A* as well as the type of charging station 106, 404 found at interim stop A can also play a factor in determining the amount of charge required by the electric vehicle 102, 200, 402. For example, if it is determined that the electric vehicle 102, 200, 402 cannot be sufficiently charged between A and A* (for example because the time period is too short or because the charging station 106, 406 cannot provide enough charging current) to perform the itinerary between interim destination A and B, then the minimum amount of charge required by the electric vehicle 102, 200, 402 at the depot will be adjusted to ensure that the electric vehicle 102, 200, 402 can eventually travel to interim destination B. A similar process occurs for interim destination B where the electric vehicle 102, 200, 402 also has the option of being charged, but predicted accessories 206 are required to be charged or used as part of the itinerary.

Based on the above, the energy consumption profile may be predicted based on at least one of a plurality of contextual factors. The contextual factors can be any one of the electric vehicle's 102, 200, 402 use pattern (for example, what destinations are predicted) for a similar itinerary, the vehicle's accessory 206 use pattern for a similar task, or a charge profile of at least one of the accessories 206 associated with the vehicle 102, 200, 402 requiring charge during each task of the itinerary. The contextual factors may also be based on a number of required occupants in the vehicle for each task of the itinerary. For example, if the vehicle is a utility vehicle (such as a plumbing vehicle), two or more workers may need to be present to carry out the itinerary (which may include the use of accessories 206 coupled to the vehicle 102, 200, 402 for carrying out any plumbing tasks). Additional vehicle occupants increase the weight of the electric vehicle 102, 200, 402 and will affect the predicted energy consumption in that more charge will be required to complete the itinerary. A physical characteristic (for example, the weight) of the at least one required vehicle occupants for the itinerary may also affect the prediction of the energy consumption profile. Accordingly, predicting the energy consumption profile may further comprise determining a threshold amount of energy required (for example, by a processor 304 as described with reference to FIG. 3) for a specific itinerary carried out by a specific driver using an electric vehicle 102, 200, 402 having assigned accessories 206.

In some examples, the energy consumption profile can also be predicted based on the habits of the driver of the electric vehicle 102, 200, 402. For example, Driver A may exhibit a heavy energy consumption profile, (for example, based on harsher driving, excessive tool use/recharging, AC usage, etc., whereas Driver B may have a lower energy consumption profile, for example, based on smother driving, different types of jobs, and less tool usage, etc.).

In some examples, a plurality of input parameters can be fed into a processor (such as processor 304 as described with reference to FIG. 3) as part of a machine learning algorithm to develop a model depicting the charging requirements of the itinerary based on the input parameters. Accordingly, the processor 304 can dynamically update the predicted energy consumption profile based on the number and type of input parameters. The input parameters of the machine learning algorithm can include a plurality of attributes associated with the itinerary (or the specific task(s) within the itinerary). For example, the attributes may comprise (but are not limited to): the vehicle's make and model, a driver's driving habits, a vehicle's previous use patterns for a specific itinerary (for example, previous distances traveled for previous itineraries), a vehicle's previous accessory pattern for a specific itinerary, a number of required vehicle occupants for an itinerary or a specific task, physical characteristics of at least one required vehicle occupant, and/or any other suitable contextual factors.

The model may be used to determine the contextual factors of an electric vehicle 102, 200, 402 that is predicted to carry out a similar itinerary (or similar individual tasks as part of an itinerary). Similarly, the model may be used to determine the contextual factors of a fleet of electric vehicles 102, 200, 402. The control circuitry 300 may also have access to Global Positioning System (GPS) Satellites to which the processor 304 can utilize to calculate a route for the itinerary. In addition to this, the processor 304 may have access to a server (such as the Internet) to determine if a charging port 106, 404 is present at any of the scheduled destinations in the itinerary. This data may also be fed into the machine learning algorithm to dynamically develop an accurate model pertaining to the charge required for the itinerary. Accordingly, the Predicted energy consumption profile can be dynamically updated with the implementation of the machine learning algorithm (and accordingly, adopt the charging profile and supply of charge required) to any one of the electric vehicles 102, 200, 402 within the fleet of vehicles.

Determining the charging profile of the electric vehicle may further comprise determining (for example, by processor 304) an itinerary starting time when the at least one of the plurality of electric vehicles 102, 200, 402 is required to start performing the itinerary. Following on from this, a threshold charging duration required to supply the electric vehicle 102, 200, 402 with the determined minimum amount of charge required to perform the itinerary may be determined (for example, by the processor 304). Based on the above, determining a charging start time and/or finishing time for supplying the electric vehicle 102, 200, 402 with the determined amount of charge required to perform the itinerary before the itinerary starting time may be scheduled (for example, by the processor 304). The scheduled start time may be a sufficient amount of time before the electric vehicle 102, 200, 402 is required to provide enough time for the threshold charging duration to pass before the vehicle is required.

In some examples, the charging profile may further comprise determining (for example, by processor 304) when at least one vehicle accessory 206 of the electric vehicle 102, 200, 402 is required for use during the itinerary, determining (for example, by processor 304) a threshold charging duration required to supply the at least one vehicle accessory 206 with a minimum amount of charge required for use during the itinerary, and scheduling a charging start time and/or finishing time for supplying the at least one vehicle accessory 206 with the determined minimum amount of charge required for the itinerary.

Based on the charging profile, the minimum amount of charge required for use during the itinerary may be supplied by a battery of the electric vehicle (for example, battery 204 as described with reference to FIG. 2). This may occur before a starting time of the itinerary and/or during the itinerary. For example, if the itinerary includes a worker needing to use a battery powered cordless drill on-site at destination A/B, then this drill will need to be charged by the battery 204 of the electric vehicle 102, 200, 402 before the vehicle reaches the destination A/B. However, if the itinerary includes using a plugged in accessory 206 (such as a plugged in vacuum cleaner) then the battery 204 of the electric vehicle 102, 200, 402 will have to have sufficient charge to accommodate the use of that accessory at the destination A/B and for the duration of its predicted use (for example between A and A* or B and B*).

To ensure that any accessory 206 predicted to be needed during an itinerary can be used in its intended way, a state of charge of the vehicle's battery 204 and/or a vehicle accessory 206 during the itinerary can be determined (for example, by processor 304). Based on the determined state of charge of the vehicle's battery 204 and/or the vehicle accessory 206, the charging profile of the vehicle's battery 204 and/or the vehicle accessory 206 may be updated. This update may occur by subtracting the current charge in the battery from the predicted charge requirements for the itinerary to arrive at the amount the battery needs to be charged. To further enhance the accuracy of the charging, the update may occur dynamically by feeding the information into the processor 304 and utilizing machine learning, as described above.

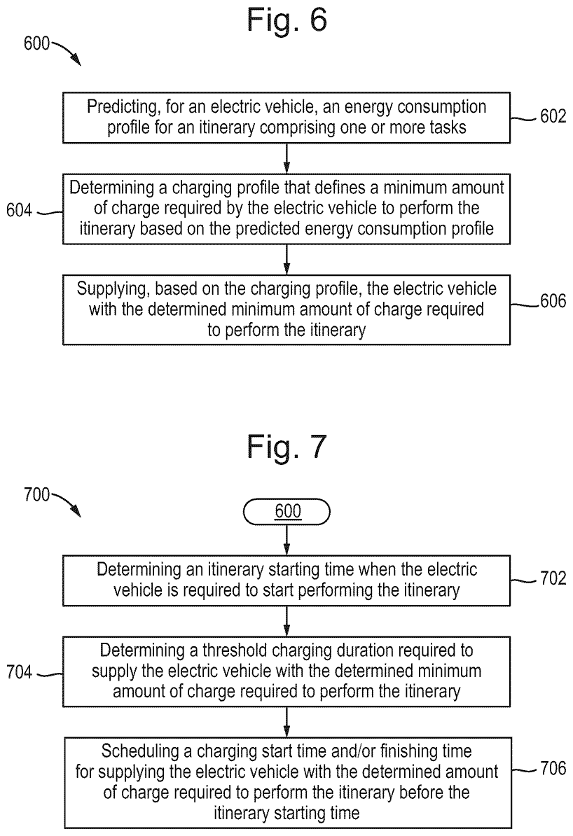

FIGS. 6 to 7 are flow charts illustrating a method of charging an electric vehicle (for example, as part of a plurality of electric vehicles within a fleet), in accordance with the systems described above with reference to FIGS. 1 to 5 and in accordance with some examples of the disclosure. While the examples shown in FIGS. 6 to 7 refer to the use of the arrangements as shown in FIGS. 1 to 5, it will be appreciated that the illustrative process shown in FIGS. 6 to 7, and any of the other following illustrative processes, may be implemented in the arrangements as described in FIGS. 1 to 5, either alone or in combination with any other appropriately configured system architecture.

At step 602, an energy consumption profile for an itinerary comprising one or more tasks is predicted for an electric vehicle (for example, electric vehicles 102, 200, 402 as described with reference to FIGS. 1 to 5 above.

At step 604, a charging profile is determined (as discussed above with reference to FIGS. 1 to 5), wherein the charging profile defines a minimum amount of charge required by the electric vehicle 102, 200, 402 to perform the itinerary based on the predicted energy consumption profile.

At step 606, the electric vehicle 102, 200, 402 is supplied with the determined minimum amount of charge required to perform the itinerary, based on the charging profile. Together, steps 602, 604 and 606 allow for a method of charging an electric vehicle 102, 200, 402.

Optionally, the steps described in FIG. 7 may be carried out. Therein, in step 702, an itinerary starting time may be determined corresponding to when the electric vehicle 102, 200, 402 is required to start performing the itinerary.

At step 704, a threshold charging duration required to supply the electric vehicle 102, 200, 402 with the determined minimum amount of charge required to perform the itinerary may be determined.

At step 706, a charging start time and/or finishing time for supplying the electric vehicle 102, 200, 402 with the determined amount of charge required to perform the itinerary before the itinerary starting time may be scheduled.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

The below items are also included in accordance with some examples of the disclosure.

Item 1 is a method of charging an electric vehicle, the method comprising: predicting, for the electric vehicle, an energy consumption profile for an itinerary comprising one or more tasks; determining a charging profile that defines a minimum amount of charge required by the electric vehicle to perform the itinerary based on the predicted energy consumption profile; and supplying, based on the charging profile, the electric vehicle with the determined minimum amount of charge required to perform the itinerary.

Item 2 is a method of item 1, wherein the predicted energy consumption profile comprises at least one of: an amount of energy for traveling between locations associated with the itinerary; and utilizing at least one vehicle accessory associated with performing the itinerary.

Item 3 is a method of items 1 to 2, wherein the energy consumption profile is predicted based on the habits of a driver of the vehicle.

Item 4 is a method of items 1 to 3, wherein the energy consumption profile is predicted based on at least one of a plurality of contextual factors, the contextual factors comprising at least one of: a vehicle use pattern; a vehicle accessory use pattern; a number of required vehicle occupants for each task of the itinerary; a physical characteristic of at least one required vehicle occupants for each task of the itinerary; and a charge profile of at least one accessory associated with the vehicle requiring charge during each task of the itinerary.

Item 5 is a method of items 1 to 4, wherein predicting the energy consumption profile further comprises determining a threshold amount of energy required for a specific itinerary carried out by a specific driver using a vehicle having assigned accessories.

Item 6 is a method of items 1 to 5, wherein predicting the energy consumption profile further comprises implementing machine learning to dynamically update the predicted energy consumption profile.

Item 7 is a method of items 1 to 6, wherein determining the charging profile comprises: determining an itinerary starting time when the electric vehicle is required to start performing the itinerary; determining a threshold charging duration required to supply the electric vehicle with the determined minimum amount of charge required to perform the itinerary; and scheduling a charging start time and/or finishing time for supplying the electric vehicle with the determined amount of charge required to perform the itinerary before the itinerary starting time.

Item 8 is a method of items 1 to 7, wherein the charging profile comprises: determining when at least one vehicle accessory of the electric vehicle is required for use during the itinerary; determining a threshold charging duration required to supply the at least one vehicle accessory with a minimum amount of charge required for use during the itinerary; and scheduling a charging start time and/or finishing time for supplying the at least one vehicle accessory with the determined minimum amount of charge required for use during the itinerary.

Item 9 is a method of items 1 to 8, further comprising: supplying, based on the charging profile, the at least one vehicle accessory with the minimum amount of charge required for use during the itinerary from a vehicle battery.

Item 10 is a method of items 1 to 9, further comprising: determining a state of charge of a vehicle battery and/or a vehicle accessory during the itinerary; and updating the charging profile during the itinerary based on the determined state of charge of the vehicle battery and/or the vehicle accessory.

Item 11 is a system for charging an electric vehicle, the system comprising a processor operable to: predict, for electric vehicle, an energy consumption profile for an itinerary comprising one or more tasks, and determine a charging profile that determines a minimum amount of charge required by the electric vehicle to perform the itinerary based on the predicted energy consumption profile; and charging circuitry controlled by the processor, the charging circuitry operable to supply, based on the charging profile, the electric vehicle with the determined minimum amount of charge required to perform the itinerary.

Item 12 is a system of item 11, wherein the predicted energy consumption profile comprises at least one of: an amount of energy for traveling between locations associated with the itinerary; and utilizing at least one accessory associated with the performing itinerary.

Item 13 is a system of items 11 to 12, wherein the energy consumption profile is predicted based on the habits of a driver of the vehicle.

Item 14 is a system of items 11 to 13, wherein the energy consumption profile is predicted based on at least one of a plurality of contextual factors, the contextual factors comprising at least one of: a vehicle use pattern; a vehicle accessory use pattern; a number of required vehicle occupants for the each task of the itinerary; a physical characteristic of at least one required vehicle occupants for each task of the itinerary; and a charge profile for at least one accessory associated with the vehicle requiring charge during each task of the itinerary.

Item 15 is a system of items 11 to 14, wherein to predict the energy consumption profile further comprises the processor being operable to determine a threshold amount of energy required for a specific itinerary carried out by a specific driver using a vehicle having assigned accessories.

Item 16 is a system of items 11 to 15, wherein predicting the energy consumption profile further comprises the processor being operable to implement machine learning to dynamically update the predicted energy consumption profile.

Item 17 is a system of items 11 to 16, wherein the processor is further operable to:

determine an itinerary starting time when the electric vehicle is required to start performing the itinerary; determine a threshold charging duration required to supply the electric vehicle with the determined minimum amount of charge required to perform the itinerary; and schedule a charging start time and/or finishing time for supplying the electric vehicle with the determined amount of charge required to perform the itinerary before the itinerary starting time.

Item 18 is a system of items 11 to 17, wherein the charging profile comprises: determining, by the processor, when at least one vehicle accessory of the electric vehicle is required for use during the itinerary; determining, by the processor, a threshold charging duration required to supply the at least one vehicle accessory with a minimum amount of charge required for use during the itinerary; and scheduling, by the processor, a charging start time and/or finishing time for supplying the at least one vehicle accessory with the determined minimum amount of charge required for use during the itinerary.

Item 19 is a system of items 11 to 18, wherein the charging circuitry is further operable to: supply, based on the charging profile, the at least one vehicle accessory with the minimum amount of charge required for use during the itinerary from a vehicle battery.

Item 20 is a system of items 11 to 19, wherein the processor is further operable to: determine a state of charge of a vehicle battery and/or a vehicle accessory during the itinerary; and update the charging profile during the itinerary based on the determined state of charge of the vehicle battery and/or the vehicle accessory.

Item 21 is a vehicle comprising the system of items 11 to 20.

What is claimed is:

1. A method of charging an electric vehicle, the method comprising:
predicting, for the electric vehicle, an energy consumption profile for an itinerary comprising one or more tasks;
determining a charging profile that defines a minimum amount of charge required by the electric vehicle to perform the itinerary based on the predicted energy consumption profile; and
supplying, based on the charging profile, the electric vehicle with the determined minimum amount of charge required to perform the itinerary.

2. The method of claim 1, wherein the predicted energy consumption profile comprises at least one of:
an amount of energy for traveling between locations associated with the itinerary; and
utilizing at least one vehicle accessory associated with performing the itinerary.

3. The method of claim 1, wherein the energy consumption profile is predicted based on the habits of a driver of the vehicle.

4. The method of claim 1, wherein the energy consumption profile is predicted based on at least one of a plurality of contextual factors, the contextual factors comprising at least one of:
a vehicle use pattern;
a vehicle accessory use pattern;
a number of required vehicle occupants for each task of the itinerary;
a physical characteristic of at least one required vehicle occupants for each task of the itinerary; and
a charge profile of at least one accessory associated with the vehicle requiring charge during each task of the itinerary.

5. The method of claim 1, wherein predicting the energy consumption profile further comprises determining a threshold amount of energy required for a specific itinerary carried out by a specific driver using a vehicle having assigned accessories.

6. The method of claim 1, wherein predicting the energy consumption profile further comprises implementing machine learning to dynamically update the predicted energy consumption profile.

7. The method of claim 1, wherein determining the charging profile comprises:
determining an itinerary starting time when the electric vehicle is required to start performing the itinerary;
determining a threshold charging duration required to supply the electric vehicle with the determined minimum amount of charge required to perform the itinerary; and
scheduling a charging start time and/or finishing time for supplying the electric vehicle with the determined amount of charge required to perform the itinerary before the itinerary starting time.

8. The method of claim 1, wherein the charging profile comprises:
determining when at least one vehicle accessory of the electric vehicle is required for use during the itinerary;
determining a threshold charging duration required to supply the at least one vehicle accessory with a minimum amount of charge required for use during the itinerary; and
scheduling a charging start time and/or finishing time for supplying the at least one vehicle accessory with the determined minimum amount of charge required for use during the itinerary.

9. The method of claim 1, further comprising:
supplying, based on the charging profile, the at least one vehicle accessory with the minimum amount of charge required for use during the itinerary from a vehicle battery.

10. The method of claim 1, further comprising:
determining a state of charge of a vehicle battery and/or a vehicle accessory during the itinerary; and
updating the charging profile during the itinerary based on the determined state of charge of the vehicle battery and/or the vehicle accessory.

11. A system for charging an electric vehicle, the system comprising a processor operable to:
predict, for electric vehicle, an energy consumption profile for an itinerary comprising one or more tasks, and
determine a charging profile that determines a minimum amount of charge required by the electric vehicle to perform the itinerary based on the predicted energy consumption profile; and
charging circuitry controlled by the processor, the charging circuitry operable to supply, based on the charging profile, the electric vehicle with the determined minimum amount of charge required to perform the itinerary.

12. The system of claim 11, wherein the predicted energy consumption profile comprises at least one of:
an amount of energy for traveling between locations associated with the itinerary; and
utilizing at least one accessory associated with the performing itinerary.

13. The system of claim 11, wherein the energy consumption profile is predicted based on the habits of a driver of the vehicle.

14. The system of claim 11, wherein the energy consumption profile is predicted based on at least one of a plurality of contextual factors, the contextual factors comprising at least one of:
a vehicle use pattern;
a vehicle accessory use pattern;
a number of required vehicle occupants for the each task of the itinerary;
a physical characteristic of at least one required vehicle occupants for each task of the itinerary; and
a charge profile for at least one accessory associated with the vehicle requiring charge during each task of the itinerary.

15. The system of claim 11, wherein to predict the energy consumption profile further comprises the processor being operable to determine a threshold amount of energy required for a specific itinerary carried out by a specific driver using a vehicle having assigned accessories.

16. The system of claim 11, wherein predicting the energy consumption profile further comprises the processor being operable to implement machine learning to dynamically update the predicted energy consumption profile.

17. The system of claim 11, wherein the processor is further operable to:
determine an itinerary starting time when the electric vehicle is required to start performing the itinerary;
determine a threshold charging duration required to supply the electric vehicle with the determined minimum amount of charge required to perform the itinerary; and
schedule a charging start time and/or finishing time for supplying the electric vehicle with the determined amount of charge required to perform the itinerary before the itinerary starting time.

18. The system of claim 11, wherein the charging profile comprises:
determining, by the processor, when at least one vehicle accessory of the electric vehicle is required for use during the itinerary;
determining, by the processor, a threshold charging duration required to supply the at least one vehicle accessory with a minimum amount of charge required for use during the itinerary; and
scheduling, by the processor, a charging start time and/or finishing time for supplying the at least one vehicle accessory with the determined minimum amount of charge required for use during the itinerary.

19. The system of claim 11, wherein the charging circuitry is further operable to:
supply, based on the charging profile, the at least one vehicle accessory with the minimum amount of charge required for use during the itinerary from a vehicle battery.

20. The system of claim 11, wherein the processor is further operable to:
determine a state of charge of a vehicle battery and/or a vehicle accessory during the itinerary; and
update the charging profile during the itinerary based on the determined state of charge of the vehicle battery and/or the vehicle accessory.

21. A vehicle comprising the system of claim 11.
